(19) United States
(12) Patent Application Publication
(10) Pub. No.: US 2006/0130103 A1
(43) Pub. Date: Jun. 15, 2006

(54) Video playback device

(75) Inventors: Seiichi Muroya, Osaka (JP); Tadashi Shibata, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/247,519

(22) Filed: Oct. 12, 2005

(30) Foreign Application Priority Data
Dec. 10, 2004 (JP) 2004-357661

(51) Int. Cl. H04N 7/16; H04N 7/173; H04N 5/44

(52) U.S. Cl. 725/100; 348/725; 725/89; 725/134; 725/142

(57) ABSTRACT

A video playback device of decoding encoded video data is additionally provided with a compression circuit and a decompression circuit in an existing encoded video decoding circuit. In the compression circuit, a frequency transform circuit transforms played-back video data obtained from the encoded video decoding circuit into frequency coefficient data, which is in turn subjected to IDCT having a reduced order in a frequency compression circuit to obtain compressed video data. The compressed video data, which is image space data having a reduced image size, is stored in a frame memory. The decompression circuit comprises a frequency decompression circuit and an inverse frequency transform circuit which performs a process inverse to that of the compression circuit. The compressed video data from the frame memory is converted by a video output circuit into data which can be displayed, and the resultant data is output to a video display device. Therefore, the additional components are provided while the existing device is used as it is, thereby reducing the size of a frame memory.

### CROSS REFERENCE TO RELATED APPLICATIONS

This Non-provisional application claims priority under 35 U.S.C. §119(a) on Patent Application No. 2004-357661 filed in Japan on Dec. 10, 2004, the entire contents of which are hereby incorporated by reference.

### BACKGROUND OF THE INVENTION

The present invention relates to a video playback device of playing back video, such as a moving picture or the like, from encoded video data. More particularly, the present invention relates to a technology of reducing the size of a frame memory for storing decoded data when video data encoded with MPEG or the like is decoded and played back.

Conventionally, a technology of reducing the size of a frame memory in a process of decoding encoded moving picture data is described in TECHNICAL REPORT OF IEICE, DSP94-108 (Publication 1). This technology employs a scalable decoder. The scalable decoder is a technology of performing decoding using a portion of encoded moving picture data. Specifically, an inverse discrete cosine transform (IDCT) process having a reduced order is performed when encoded moving picture data is decoded, thereby reducing the amount of decoded moving picture data and the size of a frame memory.

Also, conventionally, Japanese Patent 3575508 (Publication 2) describes an encoded moving picture playback device as another technology of reducing the size of a frame memory. Hereinafter, the encoded moving picture playback device of Publication 2 will be described with reference to FIG. 9. Referring to FIG. 9, video data encoded with MPEG2 or the like is variable-length decoded by a variable-length decoding circuit 210 to obtain a quantized DCT coefficient, and the quantized DCT coefficient is inverse-quantized by an inverse quantization circuit 220 to obtain an N×N matrix of DCT coefficients. Here, N is equal to 8 in the case of the MPEG scheme. Thereafter, a zero-padding circuit 225 pads 0 to the N×N matrix of DCT coefficients other than a K×M portion (low frequency components) thereof to obtain a new N×N matrix of DCT coefficients, and thereafter, the resultant new N×N matrix of DCT coefficients is subjected to an inverse DCT process by an inverse DCT circuit 230 to obtain an N×N matrix of differential pixel data. An adder 240 adds the differential pixel data with reference image data read from an accumulation memory (frame memory) 260 to obtain played-back image data. The played-back image data thus recovered is further compressed again by a compression circuit 250 and the resultant data is accumulated in the accumulation memory 260.

When a block required for motion compensation is extracted, all compressed pixel data in a motion compensation block of the compressed pixel data accumulated in the accumulation memory 260 are decompressed by a decompression circuit 270, and thereafter, the resultant data is subjected to motion compensation by a motion compensation section 280, and the resultant data is output as reference image data to the adder 240. The played-back image data obtained by the adder 240 is expanded by an expander 290 to an image size required as played-back image data, and thereafter, the resultant data is successively accumulated in a display memory 291, and is output to a video display device 292.

As described above, in the technology of Publication 2, the zero-padding circuit 225 causes the DCT coefficients of high frequency components to be 0, so that the high frequency components of differential image data output by the inverse DCT circuit 230 are reduced, and therefore, the amount of image data accumulated in the accumulation memory 260 is reduced, thereby reducing the size of the accumulation memory 260.

In the technology of Publication 1, a decoded image is reduced by decreasing the order of IDCT, thereby making it possible to reduce the size of the accumulation memory 260. However, since the image size as a result of IDCT is different from the original image size, a decoding process which is performed after the IDCT process, the order of which is reduced, needs to be changed, taking it into consideration that the image sizes are different from each other.

Also in the technology of Publication 2, the size of the accumulation memory 260 can be reduced. However, the special zero-padding circuit 225 is provided after the inverse quantization circuit 220 in order to pad 0 into the DCT coefficients other than those of low frequency components to obtain a new N×N matrix of DCT coefficients. Thus, such a special structure is required. As a result, for example, the expander 290 is required in a process after the inverse DCT circuit 230, i.e., an extra special process is required.

Thus, in the above-described two conventional technologies, although the size of the accumulation memory can be effectively reduced, a portion of the existing video playback device needs to be altered, i.e., the existing video playback device cannot be used without alteration.

Also in Publication 2, the unit of played-back image data output to the video display device 292 depends on the unit of motion compensation in the motion compensation section 280 which outputs the played-back image data and is connected to the adder 240, or the unit of IDCT in the inverse DCT circuit 230. These processing units are usually a block of 8×8 pixels. However, when video is displayed on the video display device 292, pixel data needs to be output to the video display device 292 on a line-by-line basis. Therefore, the output of pixel data to the video display device 292 is delayed until all pixel data corresponding to at least one line are accumulated in the display memory 291. Therefore, in Publication 2, the display memory 291 specialized for image display is required in addition to the accumulation memory 260, and a special process is required, taking the above-described delay into consideration, so that video display cannot be achieved by ordinary display output control.

### SUMMARY OF THE INVENTION

A first object of the present invention to effectively reduce the size of a video memory, such as a frame memory or the like, while performing a decoding process for obtaining played-back video data from encoded video data without a conventional scalable decoder and zero-padding circuit.

A second object of the present invention is to provide a video playback device capable of performing ordinary video display control without additionally providing a display memory specialized for video display, in addition to the first object.

In order to achieve the first object of the present invention, encoded video data is decoded by an ordinary process, and the resultant played-back video data in an image space is frequency-transformed again to obtain frequency coefficient data, the frequency coefficient data is compressed, and the compressed data is stored in a video memory.

In order to achieve the second object of the present invention, the video memory for storing the compressed data is also used as a display memory for video display, and video is displayed on a video display device based on the compressed data in the video memory.

The present invention provides a video playback device of playing back input encoded video data comprising an encoded video decoding circuit of decoding the input encoded video data, and combining the decoded video data with reference video data to obtain played-back video data, a compression circuit of compressing the played-back video data generated by the encoded video decoding circuit to generate compressed video data, a video memory of storing the compressed video data generated by the compression circuit, and a decompression circuit of reading and decompressing predetermined compressed video data stored in the video memory, and outputting the decompressed video data, as data for generation of said reference video data, to the encoded video decoding circuit. The compression circuit includes a frequency transform circuit of frequency-transforming the played-back video data obtained by the encoded video decoding circuit to generate frequency coefficient data, and a frequency compression circuit of compressing the frequency coefficient data generated by the frequency transform circuit to generate said compressed video data. The decompression circuit includes a frequency decompression circuit of subjecting the compressed video data read from the video memory to a process inverse to the compression process of the frequency compression circuit, to generate decompressed frequency coefficient data, and an inverse frequency transform circuit of subjecting the decompressed frequency coefficient data generated by the frequency decompression circuit to a transform process inverse to the frequency transform process of the frequency transform circuit, to generate said decompressed video data.

In one example of the video playback device of the present invention, the device further comprises a video output circuit of reading out the compressed video data from the video memory, and converting the read compressed video data into data which can be video-displayed, depending on a video display format.

In one example of the video playback device of the present invention, the frequency compression circuit leaves only frequency coefficient data values corresponding to predetermined lower frequencies among a plurality of frequency coefficient data values obtained from the frequency transform circuit, and subjects the frequency coefficient data values corresponding to the predetermined lower frequencies to an inverse frequency transform process having an order less than that of the frequency transform process of the frequency transform circuit, to generate the compressed video data, and the frequency decompression circuit subjects the compressed video data read from the video memory to a frequency transform process having an order less than that of the frequency transform process of the frequency transform circuit, and with respect to the frequency-transformed compressed video data, pads 0 to frequency coefficient data values corresponding to higher frequencies not left by the frequency compression circuit, to generate the decompressed frequency coefficient data.

In one example of the video playback device of the present invention, the frequency compression circuit sets the number of bits for representing each frequency coefficient data value obtained from the frequency transform circuit, a smaller number of bits being assigned to a frequency coefficient data value corresponding to a higher frequency, and after the setting, compresses the frequency coefficient data to generate the compressed video data, and the frequency decompression circuit subjects the compressed frequency coefficient data read from the video memory to a setting process inverse to the setting process of the frequency compression circuit, to generate the decompressed frequency coefficient data.

In one example of the video playback device of the present invention, the frequency compression circuit sets a representation precision for each frequency coefficient data value obtained from the frequency transform circuit, a rougher representation precision being assigned to a frequency coefficient data value whose energy does not belong to a predetermined energy zone having a high occurrence frequency than to a frequency coefficient data value belonging to the predetermined energy zone, and after the setting, compresses the frequency coefficient data to generate the compressed video data, and the frequency decompression circuit subjects the compressed frequency coefficient data read from the video memory to a setting process inverse to the setting process of the frequency compression circuit, to generate the decompressed frequency coefficient data.

In one example of the video playback device of the present invention, the frequency compression circuit sets a representation precision for each frequency coefficient data value obtained from the frequency transform circuit, a predetermined representation precision being assigned only to a frequency coefficient data value whose energy belongs to a predetermined energy zone having a high occurrence frequency, and after the assignment, compresses the frequency coefficient data to generate the compressed video data, and the frequency decompression circuit subjects the compressed frequency coefficient data read from the video memory to a setting process inverse to the setting process of the frequency compression circuit, to generate the decompressed frequency coefficient data.

In one example of the video playback device of the present invention, the frequency compression circuit receives the frequency coefficient data from the frequency transform circuit, calculates a difference between frequency coefficient data values adjacent to each other, and after the calculation, compresses the frequency coefficient data to generate the compressed video data, and the frequency decompression circuit subjects the compressed frequency coefficient data read from the video memory to a setting process inverse to the setting process of the frequency compression circuit, to generate the decompressed frequency coefficient data.

In one example of the video playback device of the present invention, the device further comprises a compression characteristics control circuit of analyzing an occurrence frequency of energy possessed by each frequency coefficient data value generated by the frequency transform circuit, and determines compression characteristics of a compression process in the frequency compression circuit for each frequency coefficient data value, depending on the occurrence frequency. The frequency compression circuit performs a process operation based on the compression characteristics determined by the compression characteristics control circuit.

Thus, according to the present invention, encoded video data (frequency space data) is input to and decoded by an encoded video decoding circuit to obtain ordinary decoded video data (differential data, not processed by the conventional zero-padding circuit of FIG. 9) which is video space data, and thereafter, in a compression circuit, a frequency transform circuit transforms the decoded video data into frequency coefficient data again, and thereafter, the frequency coefficient data is compressed by a frequency compression circuit, and the resultant compressed video data is stored in a video memory. A decompression circuit subjects a predetermined portion of the compressed video data stored in the video memory to a process inverse to that of the compression circuit, to generate decompressed video data. The decompressed video data is input as data for generation of reference video data to an encoded video decoding circuit to generate reference video data. The reference video data and the decoded video data (differential data) are combined to generate played-back video data.

Therefore, the compressed video data obtained by the compression circuit is stored in the video memory while ordinary played-back video data is obtained by the encoded video decoding circuit. As a result, the encoded video decoding circuit has the ordinary structure, which does not include the conventional zero-padding circuit, and does not change the process of decoding encoded video data, and a compression circuit and a decompression circuit are only added, so that the amount of data stored in the video memory can be reduced, and therefore, the size of the video memory can be reduced, while suppressing a degradation in image quality.

Particularly, in the present invention, the video memory stores not only played-back video data currently obtained by the encoded video decoding circuit, but also a large amount of compressed video data previously obtained. The large amount of compressed video data stored in the video memory is used as a basis for video display on a video display device. Therefore, it is not necessary that a video display process be delayed until all pixel data corresponding to at least one line are accumulated, depending on the timing of decoding encoded video data as in conventional technologies. In addition, a display memory specialized for video display does not have to be provided in addition to the video memory.

### BRIEF DESCRIPTION OF THE DRAWINGS

FIG. 1 is a diagram illustrating a whole structure of a video playback device according to Example 1 of the present invention.

FIG. 2 is a diagram illustrating a major internal structure of the video playback device of FIG. 1.

FIG. 3 is a diagram illustrating a process flow of 2-to-1 compression of video data to be stored in a frame memory in the video playback device of FIG. 1.

FIG. 4 is a diagram illustrating a process flow of 4-to-3 compression in the video playback device of FIG. 1.

FIG. 5 is a diagram illustrating compression characteristics of video data in a video playback device according to Example 2 of the present invention.

FIG. 6 is a diagram illustrating a whole structure of a video playback device according to Example 3 of the present invention.

FIG. 7A is a diagram illustrating a relationship between each energy value of frequency coefficient data and its occurrence frequency in the video playback device of Example 3. FIG. 7B is a diagram illustrating compression characteristics of the frequency coefficient data.

FIG. 8A is a diagram illustrating another relationship between each energy value of frequency coefficient data and its occurrence frequency in the video playback device of Example 3. FIG. 8B is a diagram illustrating another compression characteristics of the frequency coefficient data.

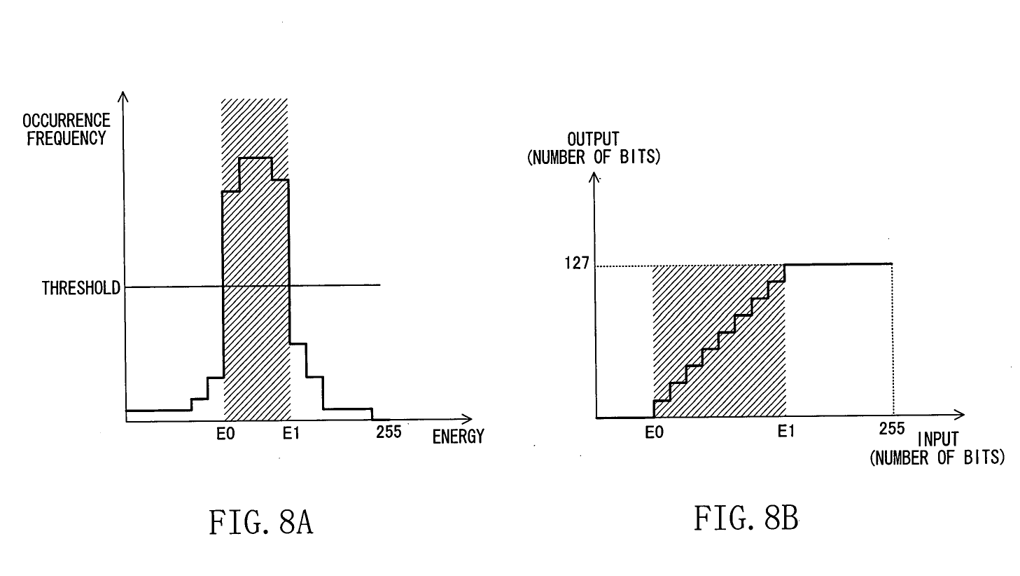

FIG. 9 is a diagram illustrating a whole structure of a conventional video playback device.

### DESCRIPTION OF THE PREFERRED EMBODIMENTS

Hereinafter, the video playback device of the present invention will be described by way of desirable examples with reference to the accompanying drawings.

### EXAMPLE 1

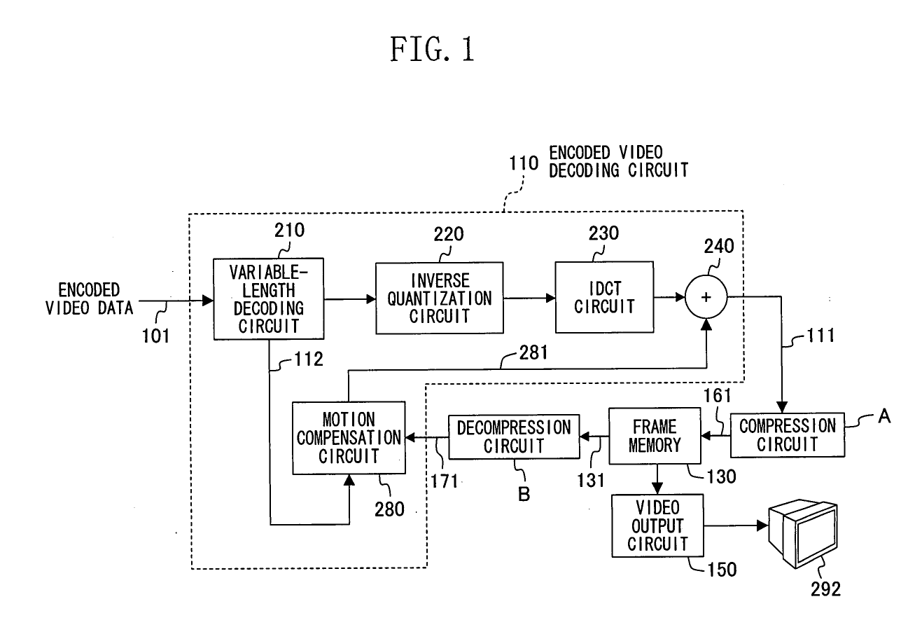

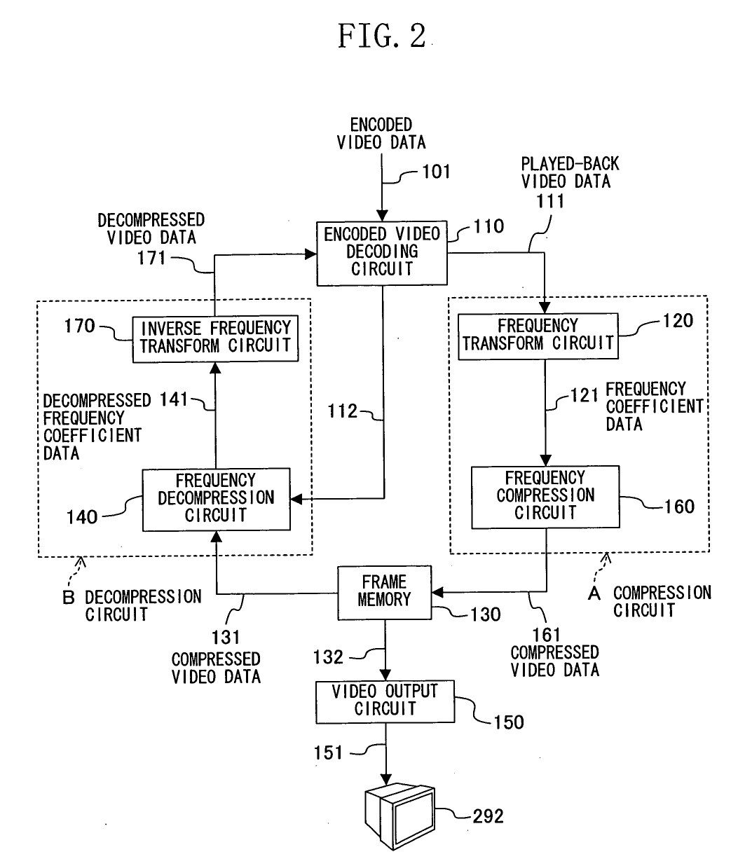

FIGS. 1 and 2 illustrate a whole structure of a video playback device according to Example 1 of the present invention.

Referring to FIGS. 1 and 2, reference numeral 110 indicates an encoded video decoding circuit, and reference numeral 130 indicates a frame memory (video memory) whose size is reduced according to the present invention. The encoded video decoding circuit 110 receives encoded video data 101 and decodes the encoded video data 101 to obtain resultant decoded video data (differential pixel data), and combines the decoded video data with predetermined reference video data to generate played-back video data 111.

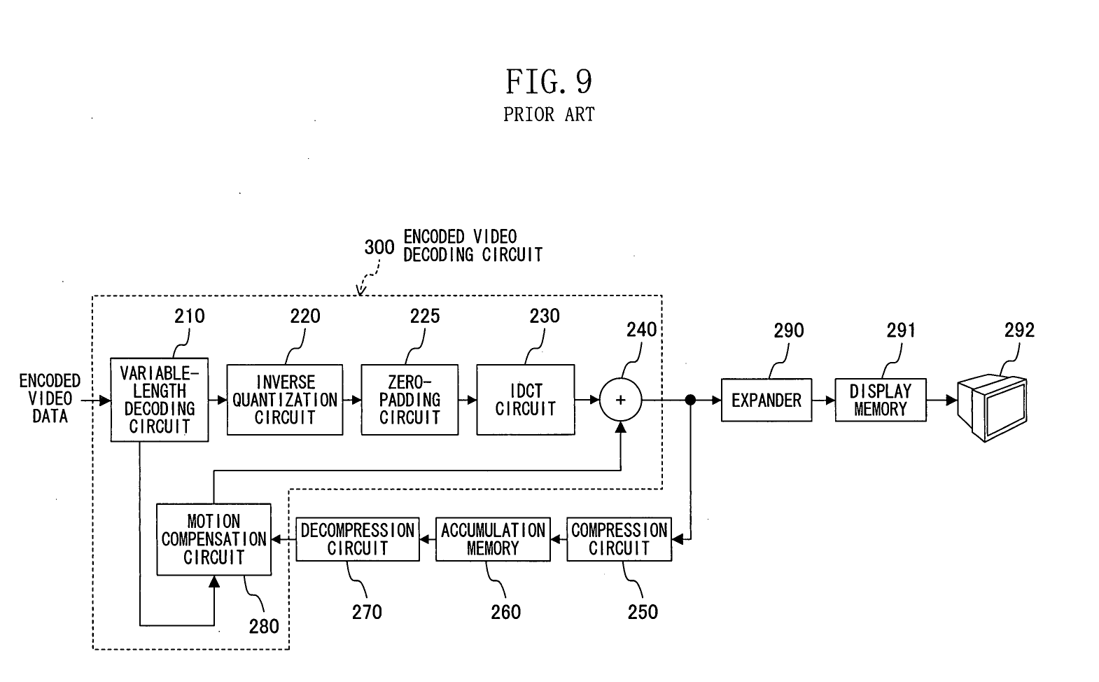

As illustrated in FIG. 1, the encoded video decoding circuit 110 comprises a variable-length decoding circuit 210, an inverse quantization circuit 220, an IDCT circuit 230, an adder 240, and a motion compensation section 280. Specifically, the encoded video decoding circuit 110 has an ordinary structure in which the zero-padding circuit 225 is removed from between the inverse quantization circuit 220 and the inverse DCT circuit 230 in the encoded video decoding circuit 300, as can be seen from the structure of the conventional video playback device of FIG. 9.

In the encoded video decoding circuit 110, the variable-length decoding circuit 210 receives and variable-length decodes the encoded video data 101 to obtain quantized DCT coefficients, and generates a reference video control signal 112 for obtaining the predetermined reference video data. The inverse quantization circuit 220 inverse-quantizes the quantized DCT coefficients from the variable-length decoding circuit 210 to obtain an N×N matrix of DCT coefficients. The IDCT circuit 230 subjects the DCT coefficients from the inverse quantization circuit 220 to an inverse DCT process to obtain an N×N matrix of differential pixel data. The motion compensation section 280 receives the reference video control signal 112 generated by the variable-length decoding circuit 210, reads predetermined stored data from the frame memory 130 based on control contents of the reference video control signal 112, performs motion compensation, and outputs the resultant data as reference video data 281 to the adder 240. The adder 240 adds the differential pixel data from the IDCT circuit 230 and the reference video data 281 from the motion compensation section 280, and outputs played-back video data 111.

In FIGS. 1 and 2, a compression circuit A, a decompression circuit B, and a video output circuit 150 are provided in addition to the encoded video decoding circuit 110.

The compression circuit A comprises a frequency transform circuit 120 and a frequency compression circuit 160. The frequency transform circuit 120 frequency-transforms again the decoded video data 111, which has been transformed from frequency space data to image space data in the encoded video decoding circuit 110, to generate frequency coefficient data 121. The frequency compression circuit 160 reduces the data amount of the frequency coefficient data 121 generated by the frequency transform circuit 120, leaving only a lower frequency portion of the frequency coefficient data 121, and thereafter, subjects the resultant frequency coefficient data 121 having the reduced data amount to an inverse frequency transform process using an order which is less than the order of the transform process in the frequency transform circuit 120 to generate compressed video data 161. The compressed video data 161 is output to and stored in the frame memory 130.

The decompression circuit B comprises a frequency decompression circuit 140 and an inverse frequency transform circuit 170. The frequency decompression circuit 140 receives the reference video control signal 112 generated by the variable-length decoding circuit 210 of the encoded video decoding circuit 110, and based on the reference video control signal 112, reads out a portion of the compressed video data 161 stored in the frame memory 130, and frequency-transforms the read compressed video data 131 using an order which is less than the order of the transform process of the frequency transform circuit 120 to obtain a plurality of compressed video data values (frequency space data). Thereafter, with respect to the frequency-transformed compressed video data, the frequency decompression circuit 140 pads 0 to a higher frequency portion of the frequency coefficient data 121 which have not been left by the frequency compression circuit 160, to generate decompressed frequency coefficient data 141. The inverse frequency transform circuit 170 subjects the decompressed frequency coefficient data 141 thus generated to a transform process inverse to the transform process of the frequency transform circuit 120 to generate decompressed video data 171. The decompressed video data 171 is input as data for generation of reference video data to the motion compensation section 280 of the encoded video decoding circuit 110.

The video output circuit 150 reads out compressed video data 132 stored in the frame memory 130, expands the compressed video data 132 vertically or horizontally without further alteration, converts the resultant compressed video data 132 into a video format (PAL or the like) which allows display, and outputs the resultant data to the video display device 292.

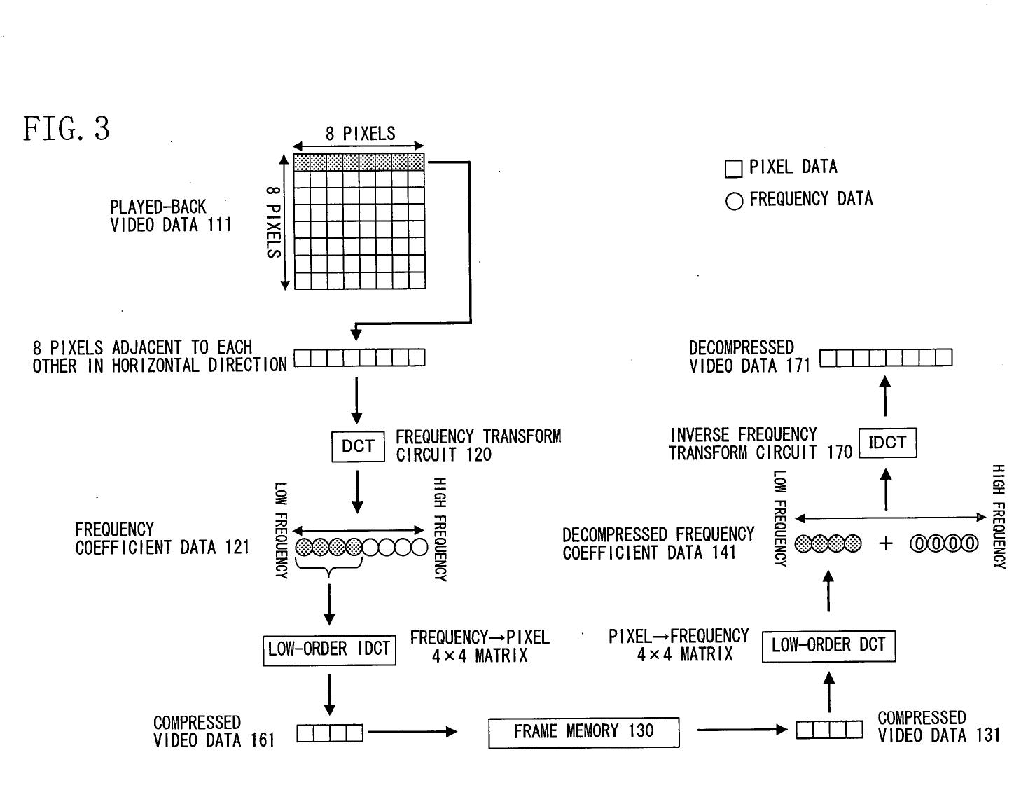

Next, an operation of the video playback device of Example 1 will be described. It is here illustrated in FIG. 3 that the size of the frame memory 130 is reduced by a factor of 2 to 1.

In the encoded video decoding circuit 110, the encoded video data 101, which has been obtained by variable-length encoding, quantization, DCT, and the like, is subjected to decoding to obtain decoded video data, and thereafter, the resultant decoded video data is added with the reference video data 281 to generate the played-back video data 111, and in addition, the reference video control signal 112 for reading reference video data required for the decoding from the frame memory 130 is generated. In the case of MPEG or the like, the encoded video decoding circuit 110 performs IDCT in units of 8×8 pixels, and therefore, the played-back video data 111 is also input to the compression circuit A in units of 8×8 pixels.

In the compression circuit A, the frequency transform circuit 120, which has received the played-back video data 111 in units of 8×8 pixels, performs DCT with respect to each 8 pixels horizontally adjacent to each other among the 8×8 pixel unit to generate 8 frequency coefficient data values 121. In this case, the DCT matrix is represented by an 8×8 matrix, and the DCT is represented by a matrix operation that 1×8 pixel data is multiplied by an 8×8 DCT matrix.

Further, in the compression circuit A, the frequency compression circuit 160 ignores four values corresponding to higher frequencies among the 8 frequency coefficient data values 121, and compresses only four values corresponding to lower frequencies among the 8 frequency coefficient data values 12, which are to be stored, to reduce the information amount by a factor of 2 to 1. Thereafter, the frequency compression circuit 160 subjects the compressed frequency coefficient data 121 to an IDCT process having a reduced order to generate pixel data corresponding to the four pixels. In this case, the IDCT matrix is represented by a 4×4 matrix, and the IDCT is represented by a matrix operation that 1×4 frequency coefficient data is multiplied by a 4×4 IDCT matrix. The pixel data corresponding to the four pixels is stored as the compressed video data 161 in the frame memory 130.

In the decompression circuit B, the decompressed video data 171, which is requested by the encoded video decoding circuit 110, is generated based on the reference video control signal 112 from the encoded video decoding circuit 110. Specifically, the frequency decompression circuit 140 reads out pixel data horizontally adjacent to each other in units of 4 pixels from the frame memory 130 (the read pixel data is the compressed video data 131, and the 4-pixel unit corresponding to the processing unit of the frequency compression circuit 160), and performs DCT having a reduced order with respect to the 4-pixel compressed video data 131 to recover the four frequency coefficient data values. In this case, the DCT matrix is represented by a 4×4 matrix which is a transposed matrix of the 4×4 IDCT matrix. The DCT is represented by a matrix operation that a 1×4 matrix pixel data is multiplied by the 4×4 DCT matrix. Further, the frequency decompression circuit 140 pads 0 to the four frequency coefficient data values corresponding to higher frequencies, which have been ignored and discarded in the frequency compression circuit 160, to generate the decompressed frequency coefficient data 141. Therefore, the decompressed frequency coefficient data 141 is composed of the four frequency coefficient data values corresponding to lower frequencies, which are the recovered frequency coefficient data itself, and the four frequency coefficient data values corresponding to higher frequencies, which are 0 (i.e., a total of 8 frequency coefficient data values).

Further, in the decompression circuit B, the inverse frequency transform circuit 170 performs IDCT, which is inverse to the transform process of the frequency transform circuit 120, with respect to the decompressed frequency coefficient data 141. In this case, the IDCT matrix is represented by an 8×8 matrix which is a transposed matrix of the 8×8 DCT matrix. The IDCT is represented by a matrix operation that a 1×8 matrix of the decompressed frequency coefficient data 141 is multiplied by an 8×8 IDCT matrix. As a result, 8 pixel data values are generated. The 8 pixel data values occupy the same position as that of the played-back video data 111 of the 8 pixels horizontally adjacent to each other, which is input to the frequency transform circuit 120, and is input as the decompressed video data 171 to the encoded video decoding circuit 110.

According to the above-described processes, the compressed video data 161 which is obtained by compressing the played-back video data 111 obtained by decoding the encoded video data 101, in the horizontal direction by a factor of 2 to 1, is stored in the frame memory 130. Therefore, the size of the frame memory 130 can be reduced to ½ of the original data amount.

The video output circuit 150 reads out the compressed video data 161 stored in the frame memory 130 in the horizontal direction, converts the compressed video data 161 into a video format (PAL or the like) which allows display, and outputs the resultant data as video having a resolution which is reduced by a factor of 2 to 1 to the video display device 292. Alternatively, the video output circuit 150 expands the read data in the horizontal direction by a factor of 1 to 2 to bring the horizontal resolution back to the original resolution, converts the resultant data into a video format which allows display, and outputs the resultant data to the video display device 292. Note that, concerning a method of expanding video in the video output circuit 150, the compressed video data 132 read from the frame memory 130 can be expanded in the horizontal direction in a manner similar to the processing method of the frequency decompression circuit 140 and the inverse frequency transform circuit 170.

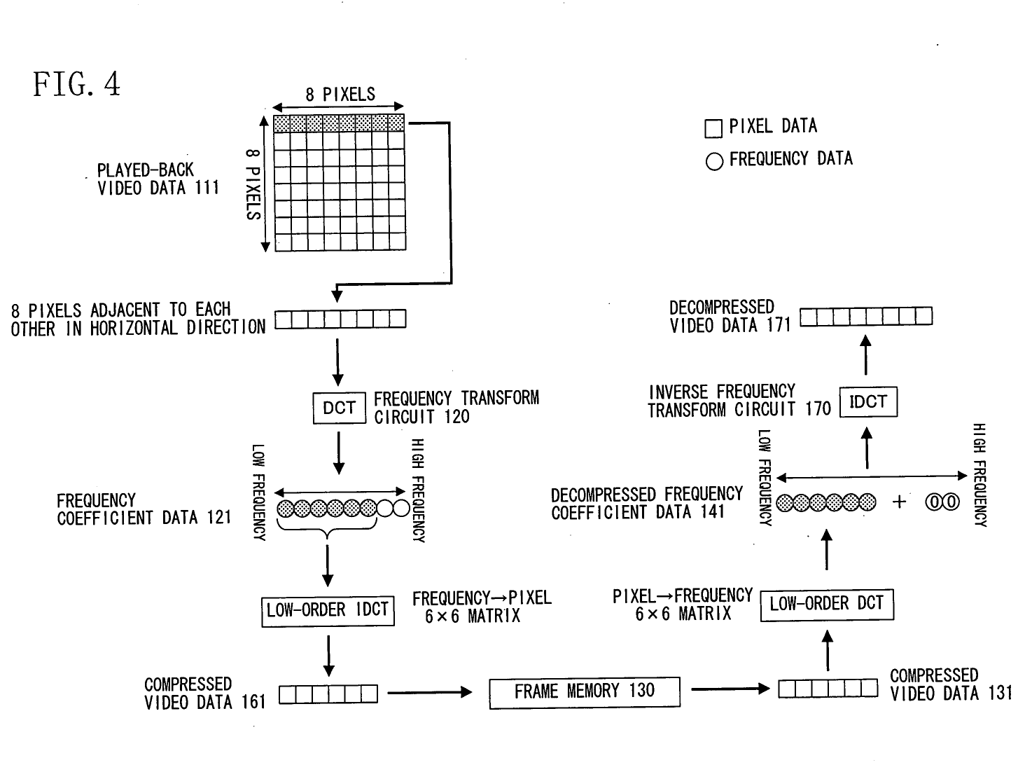

Next, an operation of the video playback device of Example 1 will be described with reference to FIG. 4, where the size of the frame memory 130 is compressed by a factor of 4 to 3.

This case is different from when compression is performed by a factor of 2 to 1 in that the frequency compression circuit 160 ignores the two frequency coefficient data values 121 corresponding to higher frequencies among the 8 frequency coefficient data values 121 corresponding to 8 pixel data values in the horizontal direction, compresses only six values corresponding to lower frequencies among the 8 frequency coefficient data values 12, which are to be stored, to reduce the information amount by a factor of 4 to 3, and subjects the compressed frequency coefficient data 121 to IDCT having a reduced order to generate pixel data corresponding to 6 pixels; the pixel data corresponding to 6 pixels is stored as the compressed video data 161 in the frame memory 130; and the frequency decompression circuit 140 performs DCT having a reduced order with respect to the pixel data corresponding to 6 pixels, which is stored in the frame memory 130, to recover 6 frequency coefficient data values, pads 0 to the two frequency coefficient data values 121 corresponding to higher frequencies other than the recovered 6 frequency coefficient data values, to generate the decompressed frequency coefficient data 141. Therefore, the size of the frame memory 130 is reduced to ¾ of the original data amount.

Although the size of the frame memory 130 is reduced by 2-to-1 or 4-to-3 compression in the horizontal direction as described above, the present invention is not limited to these. The compression ratio can be arbitrarily determined, and in addition, compression may be performed not only in the horizontal direction but also in the vertical direction, or in both the horizontal and vertical directions.

Further, the frequency compression circuit 160 and the frequency decompression circuit 140 are not limited to the structures in Example 1. Alternatively, for example, a difference between adjacent frequency coefficient data values 121 may be stored in the frequency compression circuit 160, and original frequency coefficient data may be recovered from the differential data in the frequency decompression circuit 140.

### EXAMPLE 2

Next, a video playback device according to Example 2 of the present invention will be described. Note that the whole structure of the video playback device of Example 2 is similar to that of FIGS. 1 and 2 and is not shown. The video playback device of Example 2 is different from that of Example 1 in the frequency compression circuit 160 and the frequency decompression circuit 140, which are involved in data compression and decompression.

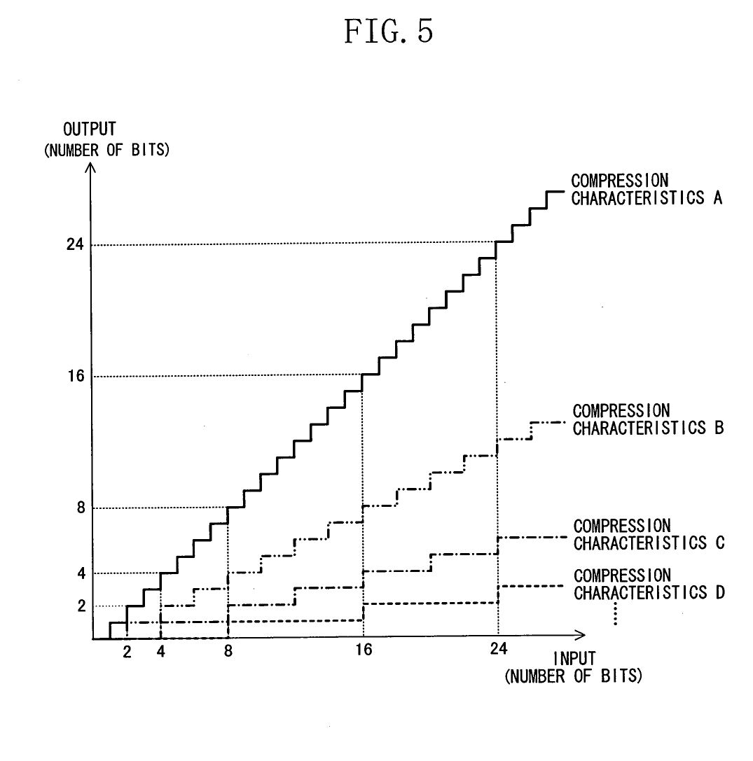

In Example 2, the frequency compression circuit 160 compresses the frequency coefficient data 121, which is an object to be compressed, based on frequency compression characteristics of the data illustrated in FIG. 5, and stores the resultant compressed frequency coefficient data into the frame memory 130. In the frequency decompression circuit 140, the compressed video data 131 read from the frame memory 130 is decompressed based on characteristics which are inverse to the compression characteristics of FIG. 5.

Hereinafter, Example 2 will be specifically described. The 8 frequency coefficient data values 121 output from the frequency transform circuit 120 are referred to as a coefficient A, a coefficient B, . . . , and a coefficient H in order of frequency (the lowest frequency, first) for the sake of convenience. It is assumed that these frequency coefficient data values 121 each have a precision of, for example, 8 bits. A higher bit precision is assigned to a frequency coefficient data value corresponding to a lower frequency according to the compression characteristics of FIG. 5. For example, 8 bits are assigned to the coefficient A, 7 bits are assigned to the coefficient B, . . . , 1 bit is assigned to the coefficient H, in accordance with compression characteristics A of FIG. 5.

Due to the above-described reduction of bit precision, the 8 frequency coefficient data values 121 having a bit precision of 8 bits per coefficient (input information having a total of 64 bits) can be compressed to a total of 36 bits. Note that the above-described bit precision assignment is only for illustrative purposes. Bit precision can be arbitrarily assigned to perform data compression.

### EXAMPLE 3

Next, a video playback device according to Example 3 of the present invention will be described.

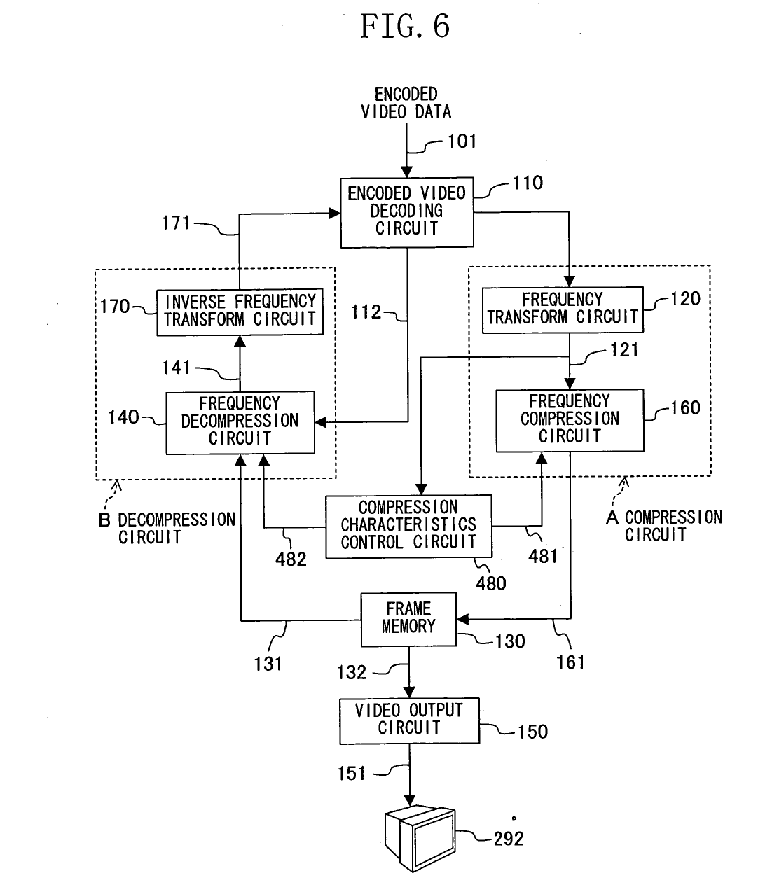

FIG. 6 illustrates a structure of the video playback device of Example 3 of the present invention. The video playback device of FIG. 6 is different from the video playback device (FIG. 2) of Example 1 in that a compression characteristics control circuit 480 is added.

The compression characteristics control circuit 480 changes compression characteristics, depending on characteristics of video to be compressed. The compression characteristics control circuit 480 determines compression characteristics based on the frequency coefficient data 121 from the frequency transform circuit 120, and outputs compression characteristics control signals 481 and 482, which are based on the determined compression characteristics, to the frequency compression circuit 160 and the frequency decompression circuit 140, respectively.

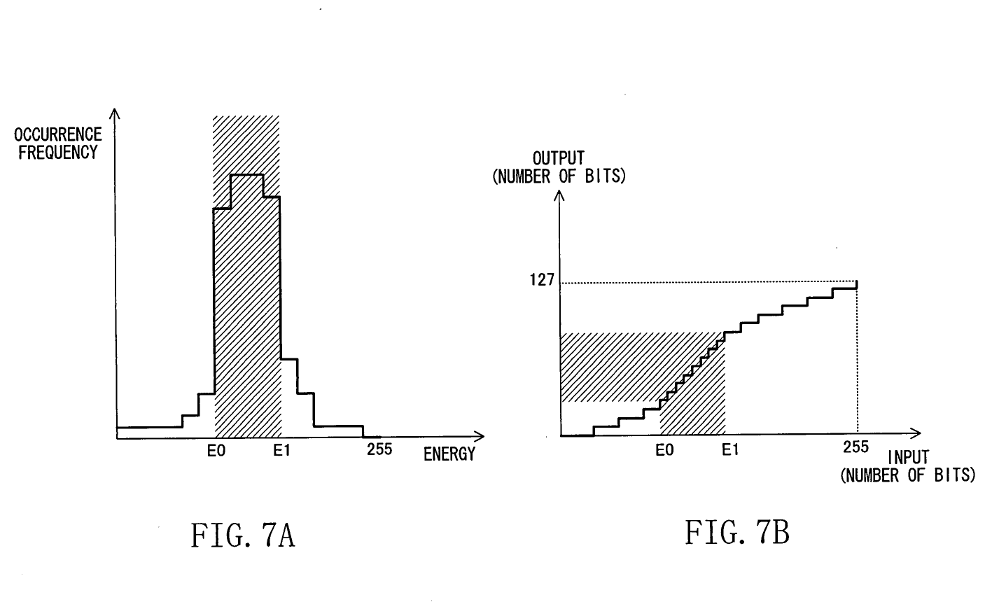

The compression characteristics control circuit 480 samples and accumulates the frequency of occurrence of energy for each frequency coefficient data value 121, and analyzes the accumulated occurrence frequency of energy to determine compression characteristics which cause a representation precision in the vicinity of energy having a lower occurrence frequency to be rougher. FIG. 7A illustrates a relationship between the energy occurrence frequency and the compression characteristics. FIG. 7A illustrates that a bias occurs in the occurrence frequency when the frequency of occurrence of an energy value of a frequency coefficient data value 121 of interest is accumulated within a predetermined period of time. In FIG. 7A, for example, high occurrence frequencies are obtained in an energy zone E0-E1. In this case, the compression characteristics control circuit 480 determines, as illustrated in an input-output graph of FIG. 7B, compression characteristics such that the precision is not changed for the energy zone E0-E1, and the precision is reduced for the other energy zones. In FIG. 7B, in order to compress the single frequency coefficient data value 121 of interest by one bit, the frequency coefficient data 121 originally represented by 8 bits (0 to 255) is converted into 7-bit (0 to 127) frequency coefficient data 121.

Note that the compression characteristics control circuit 480 may determine compression characteristics such that a threshold for the occurrence frequencies of energy values is provided to the relationship between the energy occurrence frequency and the compression characteristics, and a precision after conversion is assigned only to an energy zone E0-E1 which exceeds the threshold.

What is claimed is:

1. A video playback device of playing back input encoded video data, comprising:
an encoded video decoding circuit of decoding the input encoded video data, and combining the decoded video data with reference video data to obtain played-back video data;
a compression circuit of compressing the played-back video data generated by the encoded video decoding circuit to generate compressed video data;
a video memory of storing the compressed video data generated by the compression circuit; and
a decompression circuit of reading and decompressing predetermined compressed video data stored in the video memory, and outputting the decompressed video data, as data for generation of said reference video data, to the encoded video decoding circuit,
wherein the compression circuit includes:
a frequency transform circuit of frequency-transforming the played-back video data obtained by the encoded video decoding circuit to generate frequency coefficient data; and
a frequency compression circuit of compressing the frequency coefficient data generated by the frequency transform circuit to generate said compressed video data, and
the decompression circuit includes:
a frequency decompression circuit of subjecting the compressed video data read from the video memory to a process inverse to the compression process of the frequency compression circuit, to generate decompressed frequency coefficient data; and
an inverse frequency transform circuit of subjecting the decompressed frequency coefficient data generated by the frequency decompression circuit to a transform process inverse to the frequency transform process of the frequency transform circuit, to generate said decompressed video data.

2. The device of claim 1, further comprising:
a video output circuit of reading out the compressed video data from the video memory, and converting the read compressed video data into data which can be video-displayed, depending on a video display format.

3. The device of claim 1, wherein
the frequency compression circuit leaves only frequency coefficient data values corresponding to predetermined lower frequencies among a plurality of frequency coefficient data values obtained from the frequency transform circuit, and subjects the frequency coefficient data values corresponding to the predetermined lower frequencies to an inverse frequency transform process having an order less than that of the frequency transform process of the frequency transform circuit, to generate the compressed video data, and
the frequency decompression circuit subjects the compressed video data read from the video memory to a frequency transform process having an order less than that of the frequency transform process of the frequency transform circuit, and with respect to the frequency-transformed compressed video data, pads 0 to frequency coefficient data values corresponding to higher frequencies not left by the frequency compression circuit, to generate the decompressed frequency coefficient data.

4. The device of claim 1, wherein
the frequency compression circuit sets the number of bits for representing each frequency coefficient data value obtained from the frequency transform circuit, a smaller number of bits being assigned to a frequency coefficient data value corresponding to a higher frequency, and after the setting, compresses the frequency coefficient data to generate the compressed video data, and
the frequency decompression circuit subjects the compressed frequency coefficient data read from the video memory to a setting process inverse to the setting process of the frequency compression circuit, to generate the decompressed frequency coefficient data.

5. The device of claim 1, wherein
the frequency compression circuit sets a representation precision for each frequency coefficient data value obtained from the frequency transform circuit, a rougher representation precision being assigned to a frequency coefficient data value whose energy does not belong to a predetermined energy zone having a high occurrence frequency than to a frequency coefficient data value belonging to the predetermined energy zone, and after the setting, compresses the frequency coefficient data to generate the compressed video data, and
the frequency decompression circuit subjects the compressed frequency coefficient data read from the video memory to a setting process inverse to the setting process of the frequency compression circuit, to generate the decompressed frequency coefficient data.

6. The device of claim 1, wherein
the frequency compression circuit sets a representation precision for each frequency coefficient data value obtained from the frequency transform circuit, a predetermined representation precision being assigned only to a frequency coefficient data value whose energy belongs to a predetermined energy zone having a high occurrence frequency, and after the assignment, compresses the frequency coefficient data to generate the compressed video data, and
the frequency decompression circuit subjects the compressed frequency coefficient data read from the video memory to a setting process inverse to the setting process of the frequency compression circuit, to generate the decompressed frequency coefficient data.

7. The device of claim 1, wherein
the frequency compression circuit receives the frequency coefficient data from the frequency transform circuit, calculates a difference between frequency coefficient data values adjacent to each other, and after the calculation, compresses the frequency coefficient data to generate the compressed video data, and
the frequency decompression circuit subjects the compressed frequency coefficient data read from the video memory to a setting process inverse to the setting process of the frequency compression circuit, to generate the decompressed frequency coefficient data.

8. The device of claim 5, further comprising:
a compression characteristics control circuit of analyzing an occurrence frequency of energy possessed by each frequency coefficient data value generated by the frequency transform circuit, and determines compression characteristics of a compression process in the frequency compression circuit for each frequency coefficient data value, depending on the occurrence frequency,
wherein the frequency compression circuit performs a process operation based on the compression characteristics determined by the compression characteristics control circuit.
